(19) United States
(12) Patent Application Publication
(10) Pub. No.: US 2021/0303056 A1
(43) Pub. Date: Sep. 30, 2021

(54) BACKGROUND PROCESS MANAGEMENT FOR A DEVICE

(71) Applicant: LENOVO (Singapore) PTE. LTD., New Tech Park (SG)

(72) Inventors: Nathan J. Peterson, Oxford, NC (US); Arnold S. Weksler, Raleigh, NC (US); Russell Speight VanBlon, Raleigh, NC (US); Mark Patrick Delaney, Raleigh, NC (US); John Carl Mese, Cary, NC (US)

(21) Appl. No.: 16/835,089

(22) Filed: Mar. 30, 2020

(51) Int. Cl. G06F 1/3228; G06F 1/3212; G06F 1/3296; G06F 1/3234; G06F 9/48

(52) U.S. Cl. CPC G06F 1/3228; G06F 1/3212; G06F 9/4843; G06F 1/3243; G06F 1/3296

(57) ABSTRACT

Apparatuses, methods, systems, and program products are disclosed for background process management for a device. An apparatus includes a processor and a memory that stores code executable by the processor. The code is executable by the processor to detect that an information handling device is idle for a threshold period of time. The code is executable by the processor to determine an application that is executing in the background on the information handling device while it is idle. The code is executable by the processor to decrease a frequency with which the application that is executing in the background performs tasks based on an amount of time that the information handling device has been idle.

### FIELD

The subject matter disclosed herein relates to electronic devices and more particularly relates to background process management for a device.

### BACKGROUND

Applications that execute on an electronic device may continue executing in the background even when the device is not actively being interacted with. The applications may perform tasks in the background that consume the electronic device's power over time.

### BRIEF SUMMARY

Apparatuses, methods, systems, and program products are disclosed for background process management for a device. An apparatus, in one embodiment, includes a processor and a memory that stores code executable by the processor. In certain embodiments, the code is executable by the processor to detect that an information handling device is idle for a threshold period of time. In one embodiment, the code is executable by the processor to determine an application that is executing in the background on the information handling device while it is idle. In some embodiments, the code is executable by the processor to decrease a frequency with which the application that is executing in the background performs tasks based on an amount of time that the information handling device has been idle.

A method for background process management for a device, in one embodiment, includes detecting, by a processor, that an information handling device is idle for a threshold period of time. The method, in further embodiments, includes determining an application that is executing in the background on the information handling device while it is idle. In certain embodiments, the method includes decreasing a frequency with which the application that is executing in the background performs tasks based on an amount of time that the information handling device has been idle.

A computer program product for distributed trust authentication, in one embodiment, includes a computer readable storage medium having program instructions embodied therewith. In certain embodiments, the program instructions are executable by a processor to cause the processor to detect that an information handling device is idle for a threshold period of time. In some embodiments, the program instructions are executable by a processor to cause the processor to determine an application that is executing in the background on the information handling device while it is idle. In further embodiments, the program instructions are executable by a processor to cause the processor to decrease a frequency with which the application that is executing in the background performs tasks based on an amount of time that the information handling device has been idle.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for background process management for a device;

FIG. 2 is a schematic block diagram illustrating one embodiment of an apparatus for background process management for a device;

FIG. 3 is a schematic block diagram illustrating one embodiment of another apparatus for background process management for a device;

FIG. 4 is a schematic flow chart diagram illustrating one embodiment of a method for background process management for a device; and

FIG. 5 is a schematic flow chart diagram illustrating one embodiment of another method for background process management for a device.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

An apparatus, in one embodiment, includes a processor and a memory that stores code executable by the processor. In certain embodiments, the code is executable by the processor to detect that an information handling device is idle for a threshold period of time. In one embodiment, the code is executable by the processor to determine an application that is executing in the background on the information handling device while it is idle. In some embodiments, the code is executable by the processor to decrease a frequency with which the application that is executing in the background performs tasks based on an amount of time that the information handling device has been idle.

In one embodiment, an amount that the frequency decreases is dynamically determined based on an amount of battery life remaining for the information handling device and an historical amount of battery life that the application consumes when performing background tasks. In certain embodiments, the code is executable by the processor to monitor and track the historical amount of battery life of the information handling device that the application consumes while performing tasks in the background.

In one embodiment, an amount that the frequency decreases is dynamically adjusted over time while the information handling device remains idle based on an amount of battery life remaining for the information handling device. In various embodiments, the code is executable to prevent the application from performing tasks in the background while the information handling device is idle in response to one or more of an amount of battery life remaining satisfying a threshold battery life and a duration that the information handling device is idle satisfying a threshold idle time.

In one embodiment, an amount that the frequency decreases is determined based on an historical usage of the application such that the amount that the frequency decreases for the application is less than a different application that is not used as often as the application while the information handling device is not idle. In various embodiments, the frequency with which the application that is executing in the background performs tasks is not adjusted in response to the application comprising an application that is one of necessary for the information handling device to function and required to provide emergency functions.

In one embodiment, the threshold period of time that the information handling device is idle comprises a period of time that is greater than an average period of time that the information handling device is historically idle between user interactions with the information handling device.

In certain embodiments, the code is executable by the processor to dynamically reset the frequency with which the application that is executing in the background performs tasks in response to the information handling device being one or more of connected to a power source and interacted with by a user. In one embodiment, the information handling device is considered to be idle in response to the information handling device being free of user interaction for the threshold period of time.

In certain embodiments, the background task comprises one or more of checking for software updates, downloading software updates, installing software updates, retrieving electronic messages from a message server, retrieving social media data from a social media network, and pushing notifications to a user. In one embodiment, the application comprises an operating system and the background tasks comprise tasks that one or more services of the operating system perform.

A method for background process management for a device, in one embodiment, includes detecting, by a processor, that an information handling device is idle for a threshold period of time. The method, in further embodiments, includes determining an application that is executing in the background on the information handling device while it is idle. In certain embodiments, the method includes decreasing a frequency with which the application that is executing in the background performs tasks based on an amount of time that the information handling device has been idle.

In one embodiment, an amount that the frequency decreases is dynamically determined based on an amount of battery life remaining for the information handling device and an historical amount of battery life that the application consumes when performing background tasks. In certain embodiments, an amount that the frequency decreases is dynamically adjusted over time while the information handling device remains idle based on an amount of battery life remaining for the information handling device.

In one embodiment, the method includes preventing the application from performing tasks in the background while the information handling device is idle in response to one or more of an amount of battery life remaining satisfying a threshold battery life and a duration that the information handling device is idle satisfying a threshold idle time. In further embodiments, an amount that the frequency decreases is determined based on an historical usage of the application such that the amount that the frequency decreases for the application is less than a different application that is not used as often as the application while the information handling device is not idle.

In one embodiment, the frequency with which the application that is executing in the background performs tasks is not adjusted in response to the application comprising an application that is one of necessary for the information handling device to function and required to provide emergency function. In certain embodiments, the threshold period of time that the information handling device is idle comprises a period of time that is greater than an average period of time that the information handling device is historically idle between user interactions with the information handling device.

A computer program product for distributed trust authentication, in one embodiment, includes a computer readable storage medium having program instructions embodied therewith. In certain embodiments, the program instructions are executable by a processor to cause the processor to detect that an information handling device is idle for a threshold period of time.

In some embodiments, the program instructions are executable by a processor to cause the processor to determine an application that is executing in the background on the information handling device while it is idle. In further embodiments, the program instructions are executable by a processor to cause the processor to decrease a frequency with which the application that is executing in the background performs tasks based on an amount of time that the information handling device has been idle.

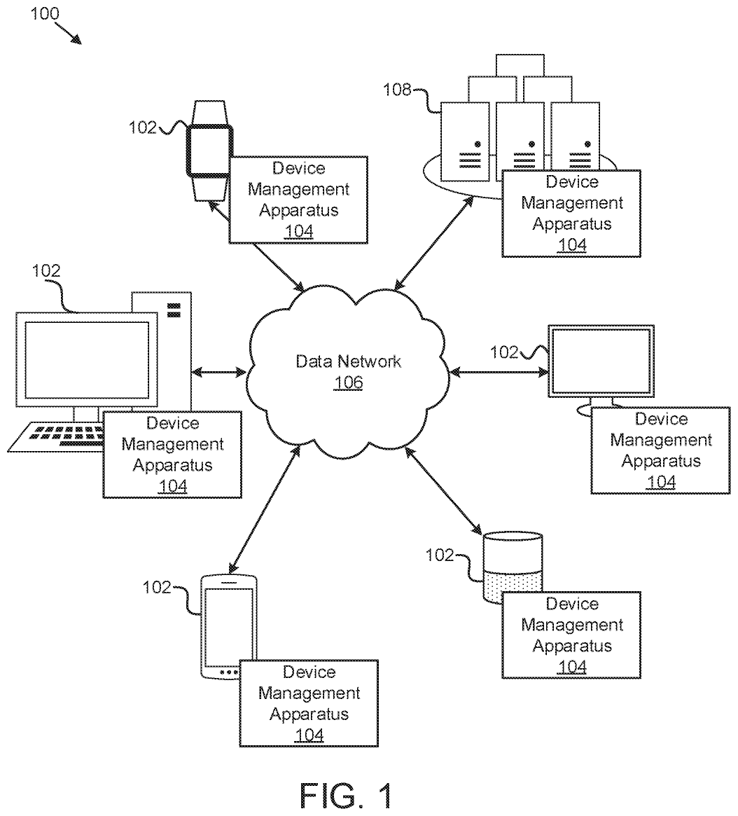

FIG. 1 is a schematic block diagram illustrating one embodiment of a system 100 for background process management for a device. In one embodiment, the system 100 includes one or more information handling devices 102, one or more device management apparatuses 104, one or more data networks 106, and one or more servers 108. In certain embodiments, even though a specific number of information handling devices 102, device management apparatuses 104, data networks 106, and servers 108 are depicted in FIG. 1, one of skill in the art will recognize, in light of this disclosure, that any number of information handling devices 102, device management apparatuses 104, data networks 106, and servers 108 may be included in the system 100.

In one embodiment, the system 100 includes one or more information handling devices 102. The information handling devices 102 may be embodied as one or more of a desktop computer, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

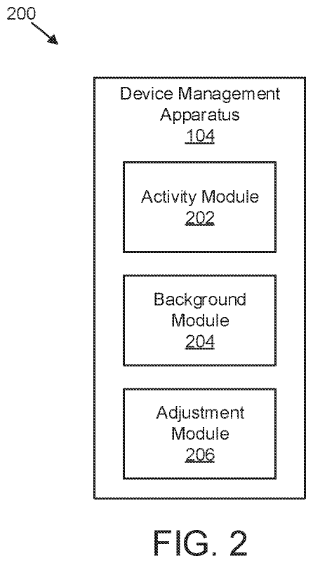

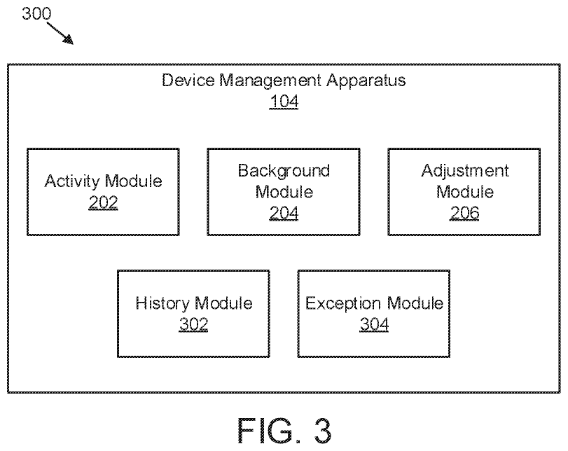

In one embodiment, the device management apparatus 104 is configured to detect that an information handling device is idle for a threshold period of time, determine an application that is executing in the background on the information handling device while it is idle, and decrease a frequency with which the application that is executing in the background performs tasks based on an amount of time that the information handling device has been idle. The device management apparatus 104, including its various sub-modules, may be located on one or more information handling devices 102 in the system 100, one or more servers 108, one or more network devices, and/or the like. The device management apparatus 104 is described in more detail below with reference to FIGS. 2 and 3.

For example, a smart phone such as an Android or iOS device may consume about 10% of its battery life per day while sitting idle. For instance, the operating system and/or applications executing on the device may check for operating system updates, application updates, emails, Twitter updates, Facebook updates, and/or the like. Generally, a user may be fine if the device does this for a day or two, or until to a certain battery life remains; however, after some amount of idle time, the user may not want an application checking for new emails every thirty minutes, for example, and may be fine with checking for emails every two hours.

The device management apparatus 104, as described herein, initiates a slow or gradual decay of the rate that background tasks execute over time. So, for instance, the first few days that a device is idle, the background applications may use 10% battery life per day, but device management apparatus 104 may adjust the execution rate of the background tasks over time so that the next few days the background tasks may execute less such that the background applications only use 7% battery life, and then further down to 5% per day, and so on, for example. In this manner, the further apart the background tasks occur, the less frequently the device has to come out of idle and consume battery life.

In various embodiments, the device management apparatus 104 may be embodied as part of an information handling device 102 such as a smart device, a network device, an Internet of Things device, a computing device, or as a hardware appliance that can be installed or deployed on an information handling device 102, on a server 108, on a user's mobile device, on a display, or elsewhere on the data network 106.

In certain embodiments, the device management apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a security system, a network router or switch, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the device management apparatus 104 may include a power interface, a wired and/or wireless network interface, a graphical interface that attaches to a display, and/or a semiconductor integrated circuit device as described below, configured to perform the functions described herein with regard to the device management apparatus 104.

The device management apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like.

In one embodiment, the device management apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the device management apparatus 104.

The semiconductor integrated circuit device or other hardware appliance of the device management apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the device management apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”) (e.g., a home network), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102.

FIG. 2 is a schematic block diagram illustrating one embodiment of an apparatus 200 for background process management for a device. In one embodiment, the apparatus 200 includes an instance of a device management apparatus 104. In one embodiment, the device management apparatus 104 includes one or more of an activity module 202, a background module 204, and an adjustment module 206, which are described in more detail below.

An activity module 202, in one embodiment, is configured to detect that an information handling device is idle for a threshold period of time. As used herein, an information handling device 102 may be considered to be idle in response to the information handling device 102 being free of user interaction for the threshold period of time. For instance, a user may not pick up, wake up, activate, push buttons, touch a touch screen, or otherwise physically interact with the information handling device 102 for a threshold period of time. In further embodiments, an information handling device 102 may be considered idle in response to a user not interacting with it using nonphysical means such as through a different device that is connected to the information handling device 102 via a data network 106, through voice commands or hand gestures, or the like.

In one embodiment, the activity module 202 tracks a continuous number of seconds, minutes, hours, days, weeks, or the like that the information handling device 102 is free of user interaction, e.g., an amount of time since the user last interacted physically, non-physically, digitally, or otherwise, with the information handling device 102. In such an embodiment, the threshold period of time that the information handling device 102 is idle is a period or amount of time that is greater than or equal to an average period of time that the information handling device 102 is historically idle between user interactions with the information handling device 102.

For instance, the activity module 202, over time, may track the amount of time that the information handling device 102 is idle, e.g., the amount of time between different two instances when a user interacts with the information handling device 102. The activity module 202 may use the tracked time data to calculate an average, minimum, maximum, or the like amount of time that the information handling device 102 is idle.

Based on the calculated times, the activity module 202 may set the threshold period of time for the information handling device 102 to be idle to be greater than or equal to the average amount of time that the information handling device 102 is idle, the maximum amount of time that the information handling device 102 is idle, the minimum amount of time that the information handling device 102 is idle, or the like.

A background module 204, in one embodiment, is configured to determine an application that is executing in the background on the information handling device 102 while it is idle. Applications, as used herein, may include executable code or software such as programs, processes, services, functions, operating systems, libraries, and/or the like that are executing on the information handling device 102.

Applications that execute “in the background” of the information handling device 102, are applications that are executing and may not currently have input focus, that may not directly receive user input, that may not have a direct user interface (e.g., services), and/or the like and perform various tasks in the background without being visible to the user, without requesting input from the user, and/or otherwise without requiring user input to execute. A background task may be an application itself, a function or feature of the application, a service, and/or the like.

Examples of applications that perform background tasks may include a social media application, email application, weather application, news application, and/or the like that may receive updates, data, and/or the like without direct user interaction, without having an interface, e.g., a graphical user interface window, that is visible to a user on a display, without having input focus on the information handling device 102, and/or the like.

In some example embodiments, the background task includes checking for software updates, downloading software updates, installing software updates, retrieving electronic messages from a message server, retrieving social media data from a social media network, pushing notifications to a user, and/or the like. The tasks may occur in the background transparently to a user, without requiring user interaction, according to a predefined schedule, without a graphical user interface, and/or the like.

In one embodiment, the application includes the operating system executing on the information handling device 102 and the background tasks that the operating system comprises includes various services that the operating system performs for managing the information handling device 102, the applications executing on the information handling device 102, and/or the like. Examples may include checking for, downloading, and installing software and security updates; memory management services; storage device services; input/output services; and/or the like.

In one embodiment, an adjustment module 206 is configured to decrease a frequency or rate with which an application that is executing in the background of the information handling device 102 performs background tasks. In certain embodiments, the adjustment module 206 adjusts the frequency that applications perform background tasks based on an amount of time that the information handling device 102 has been idle. For instance, the adjustment module 206 may gradually, periodically, according to a scale, and/or the like, over time, decrease the frequency that an application's background tasks are performed as the amount of time that the information handling device 102 is idle increases above the threshold period of time.

For example, if an application performs background tasks 10 times per minute, when the activity module 202 determines that the information handling device 102 has been idle for the threshold period of time, e.g., one day or 24 hours, the adjustment module 206 may decrease the frequency with which the application performs background tasks to eight times per minute. Over time, as the amount of time that the information handling device 102 remains idle, the adjustment module 206 continues to decrease the frequency with which the application's background tasks are performed.

Thus, in the example above, if the information handling device 102 remains idle for another day or 24 hours, the adjustment module 206 may decrease the frequency that the application executes background task to seven times per hour, and so on. The adjustment module 206 may decrease the frequency with which the application's background tasks are performed based on other factors, as described below, which may change, set, alter, modify, or the like the amount of time that the adjustment module 206 adjusts the frequency that the application's background tasks are performed.

In one embodiment, the adjustment module 206 dynamically adjusts the frequency that the application performs background tasks based on an amount of battery life that remains for the information handling device 102. For instance, if the information handling device 102 has 50% battery remaining, and the application's background tasks consume 2% of battery per day if performed at a regular schedule, the adjustment module 206 may gradually decrease the frequency with which the application performs background tasks over time as the life of the battery decreases in order to conserve the information handling device's battery life.

In some embodiments, the adjustment module 206 prevents the application from performing tasks in the background while the information handling device 102 is idle in response to an amount of battery life remaining satisfying a threshold battery life and/or a duration that the information handling device 102 is idle satisfying a threshold idle time.

For example, the adjustment module 206 may prevent an email application from performing background tasks to check for and download new email messages from a message server if doing so would cause the battery life of a user's smart phone to drop below a 20% battery life threshold. Similarly, if the information handling device 102 has been idle for a threshold idle time of one week, the adjustment module 206 may prevent a social media application from checking for and downloading new social media data.

In both instances, the adjustment module 206 prevents the application from performing background tasks in order to conserve battery life for the information handling device 102 until the user interacts with the information handling device 102 again (or until the information handling device 102 powers off due to its battery being completely consumed). In one embodiment, the threshold battery life may be determined based on historical usage of the information handling device 102, including the battery life typically consumed by applications executing on the information handling device 102. Similarly, the threshold idle time may be determined based on historical usage of the information handling device 102 such as the amount of time that the device is typically, on average, left idle prior to being interacted with.

In some embodiments, the adjustment module 206 dynamically calculates a rate in which to decrease the frequency of the application performing background tasks based on a number of factors including other application's background tasks, an amount of battery life that the background tasks consume (on average), how many background tasks are performed, an amount of battery life remaining, an amount of time that the information handling device 102 is typically idle (on average), an amount of battery life required to maintain a low power state of the device (in order to wake the device from its idle state without the device powering down), and/or the like.

The adjustment module 206 may consider one or more of the foregoing factors to calculate, estimate, predict, forecast, and/or the like, e.g., in an equation, using machine learning, and/or the like, how much to decrease a particular application's frequency of performing background tasks over time. In such an embodiment, certain factors may be weighted differently or more importantly than other factors. For instance, how much battery life a particular background task consumes may be weighted or factored more heavily than how long a device is typically idle.

In one embodiment, the adjustment module 206 dynamically resets the frequency with which the application that is executing in the background performs tasks in response to the information handling device 102 being connected to a power source and/or being interacted with by a user. For instance, when a user's smart phone is connected to a continuous power supply, e.g., plugged into an electrical outlet or shore power, or in response to a user interacting with the smart phone after being idle for an extended period of time such that the frequency with which an application's background tasks are performed is decreased, the adjustment module 206 may reset the frequency with which the application performs background tasks to a default rate, an original rate, a predefined rate, a predetermined rate, and/or the like prior to the adjustment module 206 decreasing the frequency.

FIG. 3 is a schematic block diagram illustrating one embodiment of another apparatus 300 for background process management for a device. In one embodiment, the apparatus 300 includes an instance of a device management apparatus 104. The device management apparatus 104, in certain embodiments, includes an activity module 202, a background module 204, and an adjustment module 206, which may be substantially similar to the activity module 202, the background module 204, and the adjustment module 206 described above with reference to FIG. 2. The device management apparatus 104, in further embodiments, includes one or more of a history module 302 and an exception module 304, which are described in more detail below.

The history module 302, in one embodiment, is configured to monitor and track the historical amount of battery life of the information handling device 102 that the application consumes while performing tasks in the background. The history module 302, for instance, may track, calculate, estimate, or the like an amount of battery life before and after an application's background task is performed, while compensating for, adjusting for, or the like other background tasks that may be running at the same time, e.g., the history module 302 may analyze how much memory the background process uses, how many processor cycles the background task uses, how many I/O requests the background task makes, and/or the like to determine how much of the battery usage is attributable to a particular background task.

In one embodiment, as described above, the adjustment module 206 dynamically determines an amount or rate to decrease the frequency that the application performs background tasks while the information handling device 102 is idle based on a current amount of battery life that is remaining for the information handling device 102 and an historical amount of battery life that the application consumes when performing background tasks.

In one embodiment, the history module 302 tracks, over time, usage information that describes how a user uses an application when the information handling device 102 is not idle. For instance, the history module 302 may track how much time a user spends using an application, how often the user uses an application, and/or the like, over a period of time such as the previous day, week, month, or the like. Based on the usage information, the history module 302 may rank, sort, filter, list, and/or the like the applications based on priority.

In such an embodiment, an amount that the adjustment module 206 decreases the frequency that an application performs background processes is determined based on the historical usage of the application such that the amount that the frequency decreases for the application is less than a different application that is not used as often as the application while the information handling device 102 is not idle.

For example, a social media application that a user actively uses four hours a day may be given a higher priority than an email application that the user actively uses two hours a day, and both the social media application and the email application may be given a higher priority than a news application that the user uses for less than an hour a day.

The exception module 304, in one embodiment, is configured to determine whether an application is necessary for the information handling device 102 to function, is required to provide emergency functions, and/or the like. The exception module 304 may determine that an application, or more particularly a background task for the application, is necessary for the information handling device 102 to function such as basic memory management services, storage services, I/O services, power management services, input detection services, and/or the like.

Similarly, the exception module 304 may determine that an application or a background task of the application is required for making emergency phone calls (e.g., phone calls to emergency services such as 9-1-1), providing emergency location services, providing emergency data deletion services (e.g., for deleting the data on the device in the event that it is stolen), and/or the like. Accordingly, the adjustment module 206 may not adjust the frequency with which these applications perform background processes.

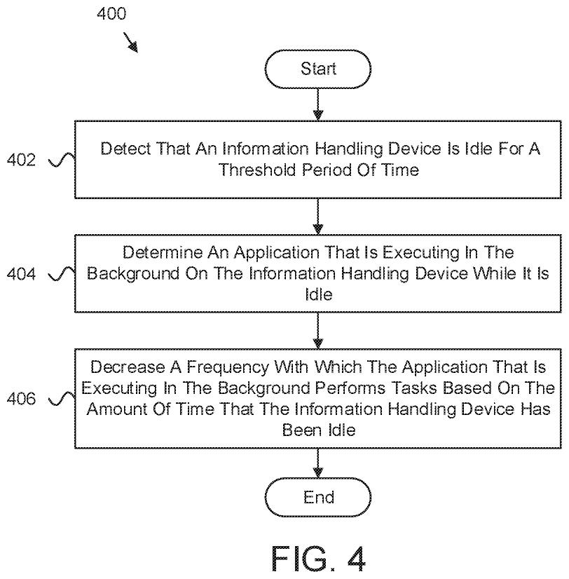

FIG. 4 is a schematic flow chart diagram illustrating one embodiment of a method 400 for background process management for a device. In one embodiment, the method 400 begins and detects 402 that an information handling device 102 is idle for a threshold period of time. In further embodiments, the method 400 determines 404 an application that is executing in the background on the information handling device 102 while it is idle.

In some embodiments, the method 400 decreases 406 a frequency with which the application that is executing in the background performs tasks based on an amount of time that the information handling device 102 has been idle, and the method 400 ends. In one embodiment, the activity module 202, the background module 204, and the adjustment module 206 perform the various steps of the method 400.

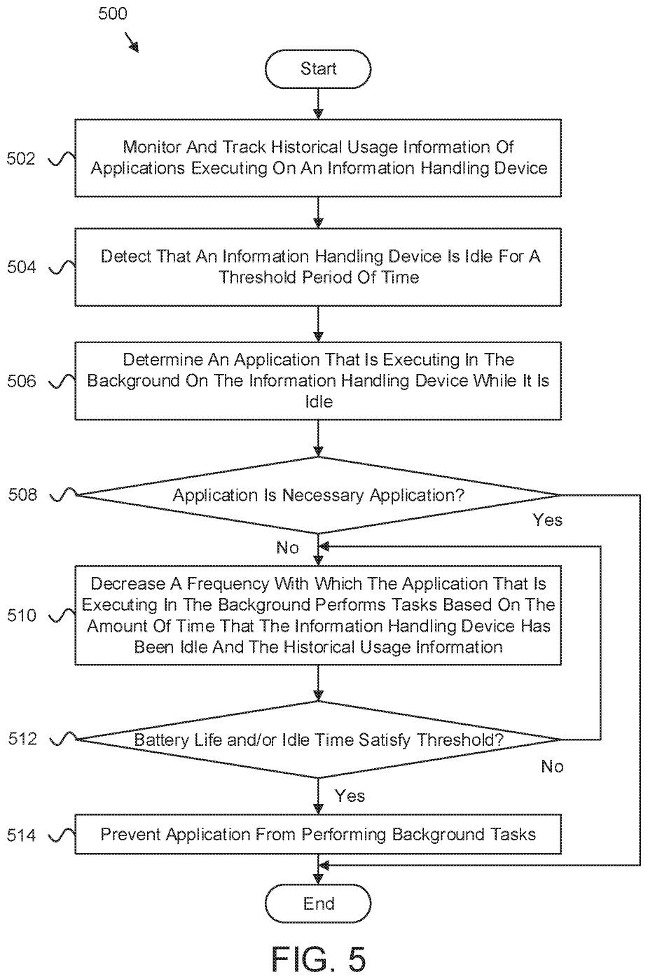

FIG. 5 is a schematic flow chart diagram illustrating one embodiment of another method 500 for background process management for a device. In one embodiment, the method 500 begins and monitors 502 and tracks historical usage information for applications that execute on the information handling device 102 when it is actively being used.

In certain embodiments, the method 500 detects 504 that an information handling device 102 is idle for a threshold period of time. In further embodiments, the method 500 determines 506 an application that is executing in the background on the information handling device 102 while it is idle.

In one embodiment, if the method 500 determines 508 that the application is a necessary application, e.g., necessary for the device to function, necessary for emergency services, or the like, then the method 500 ends. Otherwise, in various embodiments, the method 500 decreases 510 a frequency with which the application that is executing in the background performs tasks based on an amount of time that the information handling device 102 has been idle and/or the historical usage information for the information handling device 102.

In one embodiment, if the method 500 determines 512 that the battery life satisfies a battery life threshold and/or the amount of time that the information handling device 102 has been idle satisfies a threshold idle time, the method 500 continues to decrease, over time, the frequency with which the application that is executing in the background performs tasks based on the amount of time that the information handling device 102 has been idle and/or based on the amount of battery life that that remains.

Otherwise, in certain embodiments, if the method 500 determines 512 that the battery life satisfies a battery life threshold and/or the amount of time that the information handling device 102 has been idle satisfies a threshold idle time, the method 500 prevents 514 the application from performing background tasks to conserve battery life for the information handling device, and the method 500 ends. In one embodiment, the activity module 202, the background module 204, the adjustment module 206, the history module 302, and the exception module 304 perform the various steps of the method 500.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a processor; and
a memory that stores code executable by the processor to:
detect that an information handling device is idle for a threshold period of time;
determine an application that is executing in the background on the information handling device while it is idle; and
decrease a frequency with which the application that is executing in the background performs tasks based on an amount of time that the information handling device has been idle.

2. The apparatus of claim 1, wherein an amount that the frequency decreases is dynamically determined based on an amount of battery life remaining for the information handling device and an historical amount of battery life that the application consumes when performing background tasks.

3. The apparatus of claim 2, wherein the code is executable by the processor to monitor and track the historical amount of battery life of the information handling device that the application consumes while performing tasks in the background.

4. The apparatus of claim 1, wherein an amount that the frequency decreases is dynamically adjusted over time while the information handling device remains idle based on an amount of battery life remaining for the information handling device.

5. The apparatus of claim 1, wherein the code is executable to prevent the application from performing tasks in the background while the information handling device is idle in response to one or more of an amount of battery life remaining satisfying a threshold battery life and a duration that the information handling device is idle satisfying a threshold idle time.

6. The apparatus of claim 1, wherein an amount that the frequency decreases is determined based on an historical usage of the application such that the amount that the frequency decreases for the application is less than a different application that is not used as often as the application while the information handling device is not idle.

7. The apparatus of claim 1, wherein the frequency with which the application that is executing in the background performs tasks is not adjusted in response to the application comprising an application that is one of necessary for the information handling device to function and required to provide emergency functions.

8. The apparatus of claim 1, wherein the threshold period of time that the information handling device is idle comprises a period of time that is greater than an average period of time that the information handling device is historically idle between user interactions with the information handling device.

9. The apparatus of claim 1, wherein the code is executable by the processor to dynamically reset the frequency with which the application that is executing in the background performs tasks in response to the information handling device being one or more of connected to a power source and interacted with by a user.

10. The apparatus of claim 1, wherein the information handling device is considered to be idle in response to the information handling device being free of user interaction for the threshold period of time.

11. The apparatus of claim 1, wherein the background task comprises one or more of checking for software updates, downloading software updates, installing software updates, retrieving electronic messages from a message server, retrieving social media data from a social media network, and pushing notifications to a user.

12. The apparatus of claim 1, wherein the application comprises an operating system and the background tasks comprise tasks that one or more services of the operating system perform.

13. A method, comprising:
detecting, by a processor, that an information handling device is idle for a threshold period of time;
determining an application that is executing in the background on the information handling device while it is idle; and
decreasing a frequency with which the application that is executing in the background performs tasks based on an amount of time that the information handling device has been idle.

14. The method of claim 13, wherein an amount that the frequency decreases is dynamically determined based on an amount of battery life remaining for the information handling device and an historical amount of battery life that the application consumes when performing background tasks.

15. The method of claim 13, wherein an amount that the frequency decreases is dynamically adjusted over time while the information handling device remains idle based on an amount of battery life remaining for the information handling device.

16. The method of claim 13, further comprising preventing the application from performing tasks in the background while the information handling device is idle in response to one or more of an amount of battery life remaining satisfying a threshold battery life and a duration that the information handling device is idle satisfying a threshold idle time.

17. The method of claim 13, wherein an amount that the frequency decreases is determined based on an historical usage of the application such that the amount that the frequency decreases for the application is less than a different application that is not used as often as the application while the information handling device is not idle.

18. The method of claim 13, wherein the frequency with which the application that is executing in the background performs tasks is not adjusted in response to the application comprising an application that is one of necessary for the information handling device to function and required to provide emergency functions.

19. The method of claim 13, wherein the threshold period of time that the information handling device is idle comprises a period of time that is greater than an average period of time that the information handling device is historically idle between user interactions with the information handling device.

20. A computer program product, comprising a computer readable storage medium having program instructions embodied therewith, the program instructions executable by a processor to cause the processor to:
detect that an information handling device is idle for a threshold period of time;
determine an application that is executing in the background on the information handling device while it is idle; and
decrease a frequency with which the application that is executing in the background performs tasks based on an amount of time that the information handling device has been idle.
